(19) United States
(12) Patent Application Publication
(10) Pub. No.: US 2009/0196989 A1
(43) Pub. Date: Aug. 6, 2009

(54) SHARP BLADE AND ITS MANUFACTURING METHOD

(75) Inventors: Takeshi Katayama, Iwaki-shi (JP); Satoru Katsumata, Iwaki-shi (JP); Takayuki Hanami, Saitama-shi (JP); Hironori Hatono, Kitakyushu-shi (JP); Masahiro Tokita, Kitakyushu-shi (JP); Hiroaki Ashizawa, Kitakyushu-shi (JP)

Correspondence Address: DARBY & DARBY P.C., P.O. BOX 770, Church Street Station, New York, NY, 10008-0770, US

(73) Assignees: Mitsubishi Materials Corporation, Tokyo (JP); Toto Ltd., Kitakyushu-shi (JP)

(21) Appl. No.: 12/365,621

(22) Filed: Feb. 4, 2009

(30) Foreign Application Priority Data
Feb. 5, 2008 (JP) 2008025441

(51) Int. Cl. B05D 1/36; B26B 9/00

(52) U.S. Cl. 427/202; 30/353

(57) ABSTRACT

A sharp-edged blade of the invention includes a circular thin-plate-shaped abrasive grain layer 3 in which abrasive grains 2 are held in a bond phase 1. An oxide film manufactured by a sol-gel method is formed on the surface of at least the bond phase 1 of the abrasive grain layer 3 as a first protective layer 4. A thick oxide film which has polycrystals and is structured such that a grain boundary layer composed of a glass layer does not exist at an interface substantially between the crystals is formed on the surface of the first protective layer 4 as a second protective layer 5.

### BACKGROUND OF THE INVENTION

1. Field of the Invention

The present invention relates to a sharp blade and its manufacturing method to be used, for example, in the field of precision cutting, such as dicing or slicing of a semiconductor device.

Priority is claimed on Japanese Patent Application No. 2008-025441 filed Feb. 5, 2008, the content of which is incorporated herein by reference.

2. Description of Related Art

Such a sharp-edged blade for precision cutting is roughly classified into a blade of an oar blade structure which contains abrasive grains over the whole thereof, and also has an integral bond phase, a blade of a structure with a base metal which does not include an abrasive grain layer on the inner peripheral side thereof, and an oar blade of a two-layer structure which contain abrasive grains on the whole surface thereof, but has a different hardness and strength on the inner and outer peripheral sides thereof. As applications of these blades, a dicing blade with a hub for splitting silicon chips and a blade for slicing electronic components in strips, for example, are known.

As such a sharp-edged blade, an electroforming sharp-edged blade which has an annular flat-plate-shaped grindstone body obtained by dispersing abrasive grains in a metallic bond phase, and in which the projecting amount of the abrasive grains from metallic bond phase surfaces at side surfaces of the grindstone body which are directed to a thickness direction is set to less than or equal to ¼ of the mean particle diameter of the abrasive grains at least in a cutting region is suggested in, for example, Patent Unexamined Publication No. 2004-136431. Additionally, providing both ends in the thickness direction with high degree-of-concentration layers whose degree of concentration of the abrasive grains is higher at least in the cutting region than an intermediate portion is also described in this Japanese Patent Unexamined Publication No. 2004-136431.

### SUMMARY OF THE INVENTION

Recently, the degree of precision of finished dimensions of a workpiece to be cut becomes increasingly severe, and a high degree of precision such that dimensional tolerance at cutting finishing, the squareness of a cut surface, or the like is within several micrometers is required. Therefore, wear of side surfaces of a blade edge of a blade of which the workpiece cutting width changes is avoided. Thus, it is necessary to prevent a decrease in blade width due to falling of abrasive grains on portions of the side surfaces of the blade.

Additionally, the extension of the blade life is severely required, and little blade wear is desired. That is, a blade which has little wear at its tip portion and is hardly worn radially or a blade in which abrasive grains of the tip are prevented from falling off before it is worn out are required.

On the other hand, when semiconductor wafers, such as a Si wafer, are diced, a coolant is supplied to perform removal of chips or cooling of the blade. As the coolant to be used in this case, water into which a carbon dioxide gas is mixed to a lower specific resistance is used for prevention of any damage of a wafer circuit pattern caused by static electricity. However, since the carbon dioxide gas mixed into the coolant in this way, as disclosed, for example, in Japanese Patent Unexamined Publication No. 2004-136431, causes an action which, when the bond phase is a metallic bond phase, such as nickel, corrodes this metallic bond phase, this also causes deterioration of the tool life of the blade mentioned above.

The invention was made under such a background, and an object thereof is to provide a sharp-edged blade and its manufacturing method, capable of preventing abrasive grains in a blade from falling off easily even if a load is applied to the abrasive grains while a workpiece is cut, and keeping a bond phase from being corroded even in a corrosive atmosphere, such as a coolant into which a carbon dioxide gas or the like is mixed.

In order to solve the problems and achieve such an object, a sharp-edged blade of the invention includes a circular thin-plate-shaped abrasive grain layer in which abrasive grains are held in a bond phase. An oxide film manufactured by a sol-gel method is formed on the surface of at least the bond phase of the abrasive grain layer as a first protective layer. A thick oxide film which has polycrystals and is structured such that a grain boundary layer composed of a glass layer does not exist at an interface between the crystals substantially formed on the surface of the first protective layer as a second protective layer.

Here, the thick film means a film which has a thickness of 1 μm or more.

Additionally, the first protective layer is preferably formed so as to cover the bond phase at least in the vicinity of a junction between the abrasive grains and the bond phase.

Such a structure can be obtained by forming the oxide film that is the first protective layer by the sol-gel method. Since the sol-gel method is a method of forming an oxide film, using a solution, it is believed that the solution is attracted to the periphery of the abrasive grains by surface tension, and consequently, film thickness increases at a portion surrounding the abrasive grains compared with other portions. The oxide film to be formed covers the bond phase, and has excellent abrasive grain holding force and corrosion resistance particularly at the portion surrounding the abrasive grains.

Here, the first protective layer becomes thin at other portions excluding the portion surrounding the abrasive grains, and thus, stable corrosion resistance or wear resistance cannot be obtained. Then, the corrosion resistance or wear resistance of the bond phase is improved, and the wear of the bond is controlled by forming a thick oxide film as a second protective layer which has polycrystals and in which a grain boundary layer composed of a glass layer does not exist at an interface between the crystals substantially on the surface of the first protective layer.

In addition, the second protective layer is not preferably formed on the surfaces of the abrasive grains, but is formed only on the surface of the first protective layer. Since the second protective layer is not formed on the surfaces of the abrasive grains, a malfunction such that the grinding performance of the blade changes is not caused.

Additionally, the second protective layer is preferably made of an oxide having excellent corrosion resistance, such as, for example, alumina.

In order to form such the second protective layer, a method of allowing an aerosol obtained by dispersing fine particles of a brittle material in a gas to be jetted onto the first protective layer and collide with each other, thereby forming an oxide thick film, is considered.

Additionally, a method for manufacturing a sharp-edged blade of the invention includes the steps of: forming a circular thin-plate-shaped abrasive grain layer obtained by dispersing abrasive grains in a bond phase; forming a first protective layer composed of an oxide film by the sol-gel method on the surface of at least the bond phase of the abrasive grain layer; and forming the second protective layer on the surface of the first protective layer by allowing aerosol obtained by dispersing fine particles of a brittle material in the gas to be jetted and to collide with each other.

The above method is a method known as an aerosol deposition as described, for example, in Japanese Patent No. 3348154, Japanese Patent Unexamined Publication No. 2002-309383, Japanese Patent Unexamined Publication No. 2003-034003, and Japanese Patent Unexamined Publication No. 2004-091614.

The aerosol deposition is a technique of forming a thick ceramic film on various base materials, and is characterized by jetting the aerosol obtained by dispersing ceramic fine particles in the gas toward a base material from a nozzle; making the fine particles collide with the base material, such as metal, glass, ceramics, or plastics; deforming and fructuring the fine particles by the impact of this collision; joining the fine particles and the base material; and directly forming a structure made of a constituent material of the fine particles on the base material. Particularly, the structure can be formed at room temperature where a heating means is not required, and the structure which holds the mechanical strength equivalent to that of a sintered body can be obtained. An apparatus to be used for this method is basically composed of an aerosol generator which generates the aerosol, and a nozzle which jets the aerosol toward the base material. Generally, when a structure is manufactured with an area larger than an opening of the nozzle, the apparatus has a position control means which relatively moves and rocks the base and the nozzle, and when the manufacture is performed under reduced pressure, the apparatus has a chamber and a vacuum pump which form the structure, and has a gas generation source for generating the aerosol.

There is one feature in that the process temperature of the aerosol deposition is room temperature, and the structure is formed at a temperature sufficiently lower than, i.e. at a temperature hundreds of ° C. lower than, the melting point of a fine particle material.

Additionally, the fine particles to be used are mainly composed of brittle materials, such as ceramics. In addition to fine particles of the same materials which can be used independently or in combination, different kinds of fine particles can be used in combination. Additionally, some metallic materials, organic matter materials, for example, may be used while being mixed with ceramic fine particles or coated on the surfaces of the ceramic fine particles. Even in these cases, the main material for forming the structure is ceramics.

When crystalline fine particles are used as a raw material in the film structure formed by this technique, there is a feature that the film structure is a polycrystalline body whose crystallite size is smaller than the fine particles of the raw material, the crystals of the structure do not have crystal orientation substantially in many cases, it can be said that a grain boundary layer composed of a glass layer does not exist at an interface between the ceramic crystals, and a portion of the film structure forms an anchor layer which bites into the surface of the base material in many cases.

The film structure formed by this method is obviously different from a so-called powder compact in a state a form is maintained by pressure, which (powder compact) is packed with fine particles by pressure, and has sufficient strength.

Deforming and fracturing the fine particles can be determined by measuring the size of the fine particles used as the raw material and the crystallite formed film structure by an X ray diffraction method.

Phrases related to the aerosol deposition will be described below.

(Polycrystal)

In this case, the polycrystal means a structure in which crystallites are joined and built up. One crystallite substantially constitutes crystal, and its diameter is typically greater than or equal to 5 nm. Here, fine particles are not fractured, but are incorporated into a structure infrequently. In this case, the fine particles are substantially polycrystals.

(Fine Particle)

In a case where primary particles are dense particles, the fine particles are particles whose mean particle diameter identified by particle size distribution measurement or a scanning electron microscope is less than or equal to 10 μm. Additionally, in a case where primary particles are porous particles which are apt to be fructured by impact, the fine particles are particles whose mean particle diameter is less than or equal to 50 μm.

(Aerosol)

The aerosol is one obtained by dispersing the aforementioned fine particles in gases, such as helium, nitrogen, argon, oxygen, dry air, and mixed gases thereof. Although it is desirable that the aerosol is in a state where primary particles are dispersed, it typically includes agglomerated grains in which primary particles are agglomerated. The gas pressure and temperature of the aerosol are arbitrary. However, in a case where the gas pressure is converted to 1 atmosphere and the temperature is converted to 20° C., it is desirable for formation of a structure that the concentration of the fine particles in gas is within a range of 0.0003 mL/L to 5 mL/L when being jetted from a nozzle.

(Interface)

In this case, the interface means a region which constitutes a boundary between crystallites.

(Grain Boundary Layer)

The grain boundary layer is a layer having a thickness (typically several nanometers to several micrometers) located at an interface or a grain boundary called in a sintered body. Typically, the grain boundary layer takes an amorphous structure different from a crystal structure in crystal grains, and involves segregation of impurities in some cases.

With the blade according to the invention, both the first protective layer with high strength and high corrosion resistance and increases the holding force of abrasive grains at a portion surrounding the abrasive grains, and the second protective layer having a large film thickness, stable wear resistance, and corrosion resistance are formed. Thereby, since the holding force of the abrasive grains themselves increases, and the wear resistance of the bond increases, falling of abrasive grains can be prevented. Additionally, since corrosion resistance is also improved, falling of abrasive grains caused by corrosion of the bond phase can also be prevented even in a case where the blade is used in a corrosive atmosphere.

### BRIEF DESCRIPTION OF THE DRAWINGS

FIG. 1 is an enlarged sectional view showing one embodiment of a sharp-edged blade of the invention,

FIG. 2 is a further partially enlarged sectional view of one side surface of the embodiment shown in FIG. 1,

FIG. 3 is a view showing an aerosol deposition apparatus related to one embodiment of a method of manufacturing a sharp-edged blade of the invention.

### DETAILED DESCRIPTION OF THE INVENTION

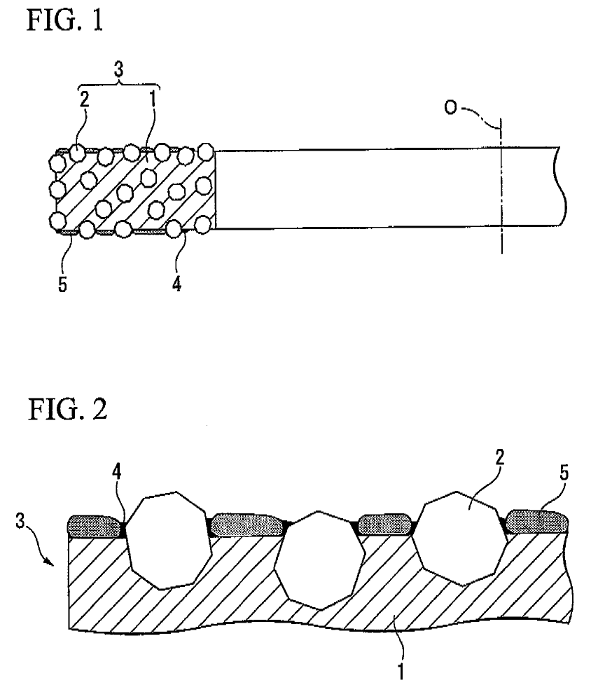

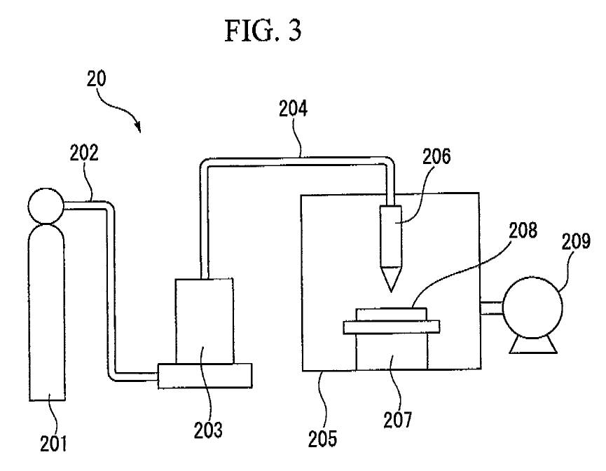

FIGS. 1 and 2 show an embodiment of a sharp-edged blade of the invention, FIG. 1 is an enlarged sectional view of this embodiment, and FIG. 2 is a further partially enlarged sectional view of one side surface of the blade of this sectional view. Additionally, FIG. 3 is a view showing an aerosol deposition apparatus related to one embodiment of a method of manufacturing a blade of the invention.

The sharp-edged blade of this embodiment, as shown in FIG. 1, forms an annular shape with an axis O as a center, and a thin plate shape (here, its thickness is shown largely in FIG. 1 for the purpose of description) having a thickness of about 0.05 to 0.5 mm, and has the above-mentioned oar blade structure where such a circular thin-plate-shaped blade is constructed by an abrasive grain layer 3 itself which is obtained by dispersing abrasive grains 2 in a bond phase 1.

Such a sharp-edged blade is attached to a spindle of a processing apparatus (not shown) as an inner peripheral portion of the abrasive grain layer 3 is inserted into the spindle and inner peripheral portions of both side surfaces of the blade are also sandwiched by a pair of flanges (not shown) or the like, and is used for precision cutting, such as dicing or slicing, or grooving of semiconductor devices as described above by its outer peripheral edges as the blade is fed in a direction perpendicular to the axis O while being rotated around the axis O.

In this embodiment, the abrasive grain layer 3 is obtained by uniformly dispersing the abrasive grains 2 composed of super abrasives, such as diamond or cBN, in the bond phase 1 composed of a metal plating phase, such as nickel. The abrasive grain layer 3 is precipitated a metal plating phase with predetermined thickness while the abrasive grains 2 are incorporated onto a base metal, and then peeling the abrasive grains from the base metal, and subjecting both the side surfaces of the blade to dressing by the well-known electroforming method.

In both side surfaces of the blade which have been subjected to dressing in this way and form an annular shape, an oxide film, such as silica or titania, which is manufactured by the sol-gel method, is formed as a first protective layer 4 on the surface of the bond phase 1 of the abrasive grain layer 3, and an alumina film with a film thickness greater than or equal to 1 μm is formed as a second protective layer 5 on the surface of the first protective layer 4 by the aerosol deposition.

In addition, in this embodiment, the first and second protective layers 4 and 5 are not formed on the inner and outer peripheral surfaces of the annular thin-plate-shaped blade in a radial direction as shown in FIG. 1. Additionally, the first and second protective layers 4 and 5 may not be formed even in the inner peripheral portions of both the side surfaces sandwiched by the pair of flanges as described above. That is, the first and second protective layers 4 and 5 may be formed at the outer peripheral edges of both the side surfaces to be substantially used for cutting or the like of a workpiece. However, the first protective layer 4, in particular, may be formed all over the blade in a case where forming the first protective layer locally in this way is rather inefficient.

Next, one embodiment of a method of manufacturing the invention will be described. First, the sol-gel method that is the technique of forming the first protective layer 4 on a blade composed of the abrasive grain layer 3 formed as described above will be described below.

After the blade composed of the abrasive grain layer 3 is immersed for one minute in a SiO₂ sol gel liquid manufactured by mixing Si(OC₂H₅)₄ and ethanol together or in a TiO₂ sol gel liquid manufactured by mixing Ti(OC₂H₅)₄ and ethanol together, the blade is dried for 2 hours at 200° C., and is processed for 8 hours at 500° C., thereby forming an oxide film. In addition, as the sol gel liquid, TiO₂, Al₂O₃, SnO₂, ZnO, VO₂, V₂O₅, MO₃, WO₃, TaO₅, and ZnO₂ may be used. Additionally, 2-propanol may be instead of ethanol.

Subsequently, the aerosol deposition that is the technique of forming the second protective layer 5 will be described below.

The aerosol deposition is characterized by spraying an aerosol obtained by dispersing fine particles of a brittle material or the like in gas toward a base material from a nozzle; making the fine particles collide with a base material, such as metal, glass, ceramics, or plastics; deforming and fracuturing the fine particles of the brittle material by the impact of this collision to join the fine particles; and directly forming a structure made of a constituent material of the fine particles on the base material. Specifically, the structure can be formed at room temperature where a heating means is not required, and a structure which has the equivalent mechanical strength of that of a sintered body can be obtained. An apparatus to be used for this method is basically composed of an aerosol generator which generates the aerosol, and a nozzle which sprays the aerosol toward the base material. Generally, when the structure is manufactured with an area larger than the opening of the nozzle, the apparatus has a position control means which moves and rocks the base and the nozzle, and when the manufacture is performed under reduced pressure, the apparatus has a chamber and a vacuum pump which form the structure, and has a gas generation source for generating the aerosol.

The process temperature of the aerosol deposition is room temperature, and the structure is formed at a temperature sufficiently lower than that is, at a temperature hundreds of ° C. lower than, the melting point of a fine particle material. Accordingly, various base materials can be selected, and even if the base material is a metal with a lower melting point or a resin material, there is no problem in application.

Additionally, the fine particles to be used are mainly composed of brittle materials, such as ceramics or semiconductors. In addition to fine particles of the same materials can be used independently or in combination, fine particles of different kinds of brittle materials can be used in combination. Additionally, some metallic materials and organic matter materials, may be used while being mixed with fine particles of brittle materials partially or coated on the surfaces of the fine particles of the brittle materials. Even in these cases, the main material for forming the structure is a brittle material.

When fine particles of a crystalline brittle material are used as a raw material in the structure formed by this technique, there is a feature that the portion of the brittle material of the structure is a polycrystalline body whose crystallite size is smaller than the fine particles of the raw material, the crystals of the structure do not have crystal orientation substantially in many cases, it can be said that a grain boundary layer composed of a glass layer does not exist at an interface between crystals of the brittle material, and a portion of the structure forms an anchor layer which bites into the surface of the base material in many cases. The film structure formed by this method is obviously different from a so-called powder compact in a state a form is maintained by pressure, which (powder compact) is packed with fine particles by pressure, and has sufficient strength.

In the formation of this structure, deforming and fracturing the brittle material fine particles can be determined by measuring the crystallite size of the fine particles of the brittle material used as a raw material and the formed structure of the brittle material by an X ray diffraction method. That is, the crystallite size of the structure formed by the aerosol deposition represents a value smaller than the crystallite size of the fine particles of the raw material. At a distorted surface or fractured surface which is formed as fine particles are fractured or deformed, a newly created surface which made bare atoms which exist inside, and are coupled with other atoms are peeled off is formed. It is believed that the structure is formed as this newly created surface whose surface energy is high is joined to the surface of an adjacent brittle material, a newly created surface of an adjacent brittle material, or a substrate surface. Additionally, when a hydroxyl group exists properly on the surface of fine particles, it is believed that a mechanochemical acid base dehydration reaction occurs by a local shearing stress caused between the fine particles or between the fine particles and a structure at the time of collision of the fine particles, and these are joined together. It is believed that these phenomena are continuously generated by the addition of a continuous mechanical impulse force from the outside, progress or sophistication of joining is performed and the structure of the brittle material grows by repetition of deforming, fracturing, or the like of fine particles.

FIG. 3 shows an aerosol deposition apparatus 20 which forms the second protective layer 5 in the blade of this embodiment. In this apparatus, an aerosol generator 203 is installed via a gas carrier pipe 202 at the tip of a nitrogen gas cylinder 201, and is connected to a nozzle 206 which is arranged within a ceramic film formation chamber 205 via an aerosol carrier pipe 204 on the downstream side thereof and which has, for example, an introduction opening with a diameter of 2 mm, and a discharge opening of 10 mm×0.4 mm. The aerosol generator 203 is charged with, for example, aluminum oxide fine particle powders. For example, a blade that is an object 208 to be coated, which is held on an XYZθ stage 207 is arranged at the tip of an opening of the nozzle 206. The ceramic film formation chamber 205 is connected with a vacuum pump 209.

The operation of the aerosol deposition apparatus 20 which forms a ceramic film will be described below.

The nitrogen gas cylinder 201 is opened to feed gas into the aerosol generator 203 through the gas carrier pipe 202, and simultaneously, the aerosol generator 203 is operated to generate the aerosol in which aluminum oxide fine particles and nitrogen gas are mixed together in a suitable ratio. Additionally, the vacuum pump 209 is operated to cause a differential pressure between the aerosol generator 203 and the ceramic film formation chamber 205. The aerosol is introduced and accelerated into the downstream aerosol carrier pipe 204 by this differential pressure, and is jetted toward the object (blade) 208 to be coated, from the nozzle 206. While the object 208 to be coated is freely rocked or rotated by the XYZθ stage 207, and changes collision positions of the aerosol, a film-like alumina film is formed at a desired position on the object 208 to be coated, by the collision of fine particles. For example, when the second protective layer 5 is formed only at the outer peripheral edges of the side surfaces of the blade as described above, the outer peripheral edges may be arranged to face the opening of the nozzle 206, and aerosol may be jetted while the blade is rotated around the axis O.

In addition, although the ceramic film formation chamber 205 is put in a pressure-reduced environment by the vacuum pump 209, it is not necessarily to put the chamber in a pressure-reduced environment, and it is also possible to form a film under atmospheric pressure. Additionally, gas is also not limited to nitrogen, but other gases, such as and helium, compressed air can be use.

Accordingly, for example, with the sharp-edged blade of the above construction manufactured by such a manufacturing method, first, an oxide film of the first protective layer 4 is formed by the sol-gel method. Therefore, the sol gel liquid as described above is attracted to the periphery of the abrasive grains 2 by surface tension. Thereby, the thickness of the film increases especially in the vicinity of a junction between the abrasive grains 2 and the bond phase 1 so as to cover the bond phase 1. For this reason, the holding force of the abrasive grains 2 can be prevented, a corrosive coolant can be prevented from oozing out from between the abrasive grains 2 and the first protective layers 4, and corroding the bond phase 1, and corrosion resistance can be improved.

On the other hand, the film thickness of the first protective layer 4 manufactured by the sol-gel method becomes small at a portion between the abrasive grains 2 other than the vicinity of the junction between the abrasive grains 2. In contrast, with the sharp-edged blade, a thick oxide film which has polycrystals and in which a grain boundary layer composed of a glass layer does not exist at an interface between the crystals substantially is formed as a second protective layer 5 on the surface of the first protective layer 4. As the portion of the first protective layer 4 whose film thickness is small is covered with such a second protective layer 5, the wear of the bond phase 1 can be controlled, thereby reliably improving abrasive grain holding force or corrosion resistance.

Moreover, with the sharp-edged blade of this embodiment and its manufacturing method, the second protective layer 5 is manufactured by the aerosol deposition, and fine particles of a brittle material in the aerosol to be jetted do not adhere to the surfaces of the abrasive grains 2, such as hard superabrasives easily. Therefore, the second protective layer 5 can be formed on the surface of the first protective layer 4 except the surfaces of the abrasive grains 2. For this reason, in the sharp-edged blade, while stable cutting or the like of a workpiece can be performed without exerting a change on grinding performance, such as the sharpness of the blade by the abrasive grains 2, and such a blade can be comparatively manufactured simply by the manufacturing method. Moreover, in this embodiment, the second protective layer 5 is made of alumina having excellent corrosion resistance. Therefore, tool life can be further extended.

Additionally, with the sharp-edged blade of this embodiment, the second protective layer 5 is formed only at the outer peripheral edges, to be used for cutting, of both side surfaces of the blade, and the inner peripheral portions are sandwiched by the flanges as described above and are not provided for cutting. Therefore, a range where the second protective layer 5 is formed can be suppressed, thereby further simplifying manufacturing processes. Additionally, in this embodiment, while the first and second protective layers 4 and 5 are formed only at the outer peripheral edges of both side surfaces in this way, the first and second protective layers 4 and 5 are not formed on the outer peripheral surface of the blade. Thus, wear of this outer peripheral surface is small on both side surfaces, and a recessed cross-sectional shape which has a large thickness at a central portion thereof is obtained. Also, since the sharpness at both side surfaces that form a cutting plane of a workpiece can be kept sharp, burrs or the like can be prevented from being generated at the workpiece.

In addition, in this embodiment, the bond phase 1 is used as the electroformed sharp-edged blade formed by a metal plating phase, such as nickel. However, the invention can be applied to a metal-bonded blade obtained by dispersing and sintering abrasive grains in metal powder. In some cases, a blade of a vitrified bond or resin bond many be used. Moreover, the invention can also be applied to a blade with a base metal (hub), or all blades of two-layer structure in which the hardness and strength of the abrasive grain layer 2 differ on the inner and outer peripheral sides, other than the oar blade structure. Also, the invention can also be applied to an inner peripheral edge blade which performs cutting or the like by an inner periphery of an annular thin-plate-shaped blade.

### WORKING EXAMPLE 1

Hereinafter, the effects of the inventions will be demonstrated by means of working examples of the invention. In Working Example 1, first, 25 vol % of diamond abrasive grains with a mean particle diameter of 50 μm was added to and mixed with alloy powders containing 90 wt % of Cu and 10 wt % of Sn, and the resulting mixture was molded and sintered, thereby fabricating an annular thin-plate-shaped metal-bonded precision blade of an oar blade type. The dimension of the blade is 60 mm in appearance, the thickness of the blade is 0.3 mm, and the internal diameter of the blade is 40 mm. This blade is used as a standard blade for first comparison, and is called Blade A.

Next, this standard blade was immersed in an SiO₂ gel sol liquid manufactured by mixing Si(OC₂H₅)₄ and ethanol in a volume ratio of 1:1. Thereafter, the blade was then dried for 2 hours at 200° C., and was processed for 8 hours at 500° C., thereby forming a silica film as a first protective layer on the whole surface of the bond phase. Subsequently, aerosol was generated at a flow rate of 7 l/min of nitrogen gas, by using alumina fine particles with a diameter of 0.6 μm by an apparatus equivalent to that of FIG. 3, and was jetted onto the surface of the blade from a nozzle, thereby forming an alumina film of a film thickness of 3 to 5 μm as a second protective layer. This blade is called Blade B in Working Example 1.

Similarly, a blade on which only the second protective layer was formed on the standard blade by the same method as the aforementioned method was manufactured. The blade is called Blade C as a blade for second comparison.

A workpiece was actually cut by these blades A to C, and the wear resistance of the blades was investigated. Here, the thickness of the workpiece was 5 mm when the workpiece was processed by a stick for dressing obtained by vitrifying and hardening alumina abrasive grains of #400. This workpiece was half-cut by using tap water for coolant during cutting at a blade revolution number of 30,000 rev/min, blade feed speed of 100 mm/second, a depth of cut of 0.8 mm into the workpiece, and the radius wear of Blades A to C in respective workpiece cut lengths of 2 m, 4 m, and 6 m was measured. The results are shown in the following Table 1.

TABLE 1

| | Accumulative wear | Accumulative wear | Accumulative wear |
|---|---|---|---|
| | when 2 m cutting is | when 4 m cutting is | when 6 m cutting is |
| | made | made | made |
| Blade A | 0.049 | 0.081 | 0.112 |
| Blade B | 0.035 | 0.066 | 0.094 |
| Blade C | 0.040 | 0.072 | 0.101 |

Unit: mm

From the results of Table 1, it was confirmed that the blade B on which two protective layers are formed has remarkable superiority in wear resistance in any of the cut lengths. Additionally, when blade surfaces after a cutting test were observed, it was confirmed that there was little falling of abrasive grains of blade side surfaces in Blade B compared with the other Blades A and C, and it was turned out that, since falling of abrasive grains can be prevented by the formation of the first and second protective layers, blade wear is suppressed.

### WORKING EXAMPLE 2

Next, in a blade which dices a Si wafer, a dicing blade of an oar blade type was manufactured as a blade with an abrasive grain content of 20 vol % and with blade dimensions having an external diameter of 50.8 mm, a blade thickness of 0.040 mm, and an internal diameter of 40 mm by using electroforming bond of a nickel plating phase as a bond phase and diamond superabrasives whose abrasive grain diameter is 3 to 5 μm as abrasive grains. The blade is called Blade D as a blade for third comparison.

Next, similarly to Working Example 1, this standard blade was immersed in an SiO₂ gel sol liquid manufactured by mixing Si(OC₂H₅)₄ and ethanol in a volume ratio of 1:1. Thereafter, the blade was then dried for 2 hours at 200° C., and was processed for 8 hours at 500° C., thereby forming a silica film as a first protective layer on the whole surface of the bond phase. Subsequently, aerosol was generated at a flow rate of 7 l/min of nitrogen gas, by using alumina fine particles with a diameter of 0.6 μm by an apparatus equivalent to that of FIG. 3, and was sprayed onto the surface of the blade from a nozzle, thereby forming an alumina film of a film thickness of 3 to 5 μm as a second protective layer. This blade is called Blade E in Working Example 2.

Then, a Si wafer on which a dicing tape was stuck with a diameter of 8 inches and a thickness of 300 μm was diced (full cutting) by Blades D and E by using ion exchange water and a mixture obtained by mixing carbon dioxide gas into the ion exchange water as a coolant, and the radius wear of each blade was measured. In addition, the processing conditions at this time were a blade revolution number of 40,000 rev/min, a blade feed speed of 50 mm/second, a workpiece cutting length of 1000 m×25 sheets. The results are shown in the following Table 2.

TABLE 2

| | | Ion exchange water + Carbon |
|---|---|---|
| | Ion exchange water | dioxide gas |
| Blade D | 0.308 | 0.513 |
| Blade E | 0.192 | 0.236 |

Unit: mm

It can be seen from the results of Table 2 that, with Blade E of Working Example 2 on which the first and second protective layers are formed, its radius wear becomes less than that of Blade D that is a comparative example even in a case where the coolant is only ion exchange water or even in a case where the coolant is a mixture obtained by carbon dioxide gas into the ion exchange water. In particular, it can be observed that an increase in the amount of wear in a case where carbon dioxide gas is mixed becomes remarkably less compared with an increase in the amount of wear in Blade D as a comparative example where carbon dioxide gas is not mixed, and the effect of suppressing corrosion by carbon dioxide gas is high.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. A sharp-edged blade comprising:
a circular thin-plate-shaped abrasive grain layer in which abrasive grains are held in a bond phase;
a first protective layer which is formed on the surface of at least the bond phase of the abrasive grain layer and which is an oxide film manufactured by a sol-gel method; and
a second protective layer which is formed on the surface of the first protective layer and which is a thick oxide film which has polycrystals and in which a grain boundary layer composed of a glass layer does not exist at an interface substantially between the crystals.

2. The sharp-edged blade of claim 1,
wherein the second protective layer is manufactured by an aerosol deposition.

3. The sharp-edged blade of claim 1,
wherein the first protective layer is formed so as to cover the bond phase at least in the vicinity of a junction between the abrasive grains and the bond phase.

4. The sharp-edged blade of claim 1,
wherein the second protective layer is alumina.

5. A method of manufacturing a sharp-edged blade, comprising the steps of:
forming a circular thin-plate-shaped abrasive grain layer obtained by dispersing abrasive grains in a bond phase;
forming a first protective layer composed of an oxide film by the sol-gel method on the surface of at least the bond phase of the abrasive grain layer; and
forming a second protective layer on the surface of the first protective layer by allowing aerosol obtained by dispersing fine particles of a brittle material in a gas to be jetted and collide with each other.
